(19) United States
(12) Patent Application Publication
(10) Pub. No.: US 2007/0029409 A1
(43) Pub. Date: Feb. 8, 2007

(54) Nozzle and Method of Use

(76) Inventor: Mark A. Dupuis, Westfield, MA (US)

Correspondence Address: DOHERTY, WALLACE, PILLSBURY & MURPHY, P.C., ONE MONARCH PLACE, SUITE 1900, 1414 MAIN STREET, SPRINGFIELD, MA, 01144-1900, US

(21) Appl. No.: 11/461,645

(22) Filed: Aug. 1, 2006

Related U.S. Application Data
(63) Continuation of application No. 60/595,794, filed on Aug. 5, 2005.

(51) Int. Cl. B05B 1/34

(52) U.S. Cl. 239/463; 239/589; 239/487

(57) ABSTRACT

A nozzle for controlling the spray pattern and the distribution of particles into a combustion chamber. The nozzle comprises a receiver in communication with a vortex chamber, which in turn is in communication with a discharge hood. The vortex chamber and the discharge hood are designed to reduce the air pressure within the nozzle, and to thereby decrease the velocity at which particles move through the nozzle. The nozzle further comprises a plurality of blades disposed on the vortex chamber which serve to control the spray pattern of the particles. The nozzle further optionally comprises a plurality of deflectors located on the discharge hood which further controls the spray pattern of the particles.

### CROSS REFERENCE TO RELATED APPLICATIONS

This application claims the benefit of U.S. Provisional Application No. 60/595,794 filed on Aug. 5, 2005.

### BACKGROUND OF THE INVENTION

1. Field of the Invention

This invention relates to a nozzle configured to control the flow of particles. More particularly this invention relates to a nozzle capable of regulating the velocity of particulate matter through the nozzle and the spray pattern of the particulate matter from the nozzle.

2. Background of the Invention

Many types of nozzles exist for conveying blown particulate matter from one medium into another. An exemplary application of a nozzle is in the combustion industry where it is desired to transfer combustible particles from a processing site to a combustion site. However, oftentimes the nozzle blows the combustible particles towards the walls of the combustion site, upon which the particles combust on or in close proximity to the walls, and thereby cause heat damage to the walls. Accordingly, what is needed is a nozzle designed to control the flow and/or spray of combustible particles such that the particles combust before they come in proximity to the walls of the combustion site.

### SUMMARY OF THE INVENTION

The above-discussed and other drawbacks and deficiencies of the prior art are overcome or alleviated by a nozzle which controls the spray pattern and the distribution of particles as they enter into and are dispersed in a combustion chamber, wherein a combustion chamber is defined as any material burning site, such as a boiler, burner, furnace, and the like. The nozzle comprises a receiver in communication with a vortex chamber, which in turn is in communication with a discharge hood. The vortex chamber and the discharge hood are designed to reduce the air pressure within the nozzle, and to thereby decrease the velocity at which particles move through the nozzle. The nozzle further comprises a plurality of blades disposed on the vortex chamber which serve to control the spray pattern of the particles. The nozzle further optionally comprises a plurality of deflectors located on the discharge hood which further controls the spray pattern of the particles.

### BRIEF DESCRIPTION OF THE DRAWINGS

FIG. 1 is a schematic depicting a side view of the outer surface of an exemplary nozzle;

FIG. 2 is a schematic depicting a bottom view of a portion of the nozzle depicted in FIG. 1;

FIG. 3 is a schematic depicting a longitudinal view of an interior of the nozzle depicted in FIG. 1;

FIG. 4 is a schematic depicting a bottom view of the nozzle of FIG. 1 showing the discharge hood and plurality of deflectors;

FIG. 5 is a schematic depicting an exemplary starting material used to form an exemplary deflector; and

FIG. 6 is a schematic depicting a transparent side view of the nozzle depicted in FIG. 1 attached to an exemplary piping.

### DETAILED DESCRIPTION OF THE INVENTION

Disclosed herein is a nozzle which directs the speed and flow of particles. The nozzle is more particularly described with reference to the figures, however, the disclosure is not to be limited to the embodiments shown in the figures, but is intended to include all obvious and natural variations and modifications thereof as would occur to one of ordinary skill in the art.

Referring to the figures, an exemplary nozzle 10 comprises a receiver 11 connected to a truncated conical vortex chamber 12, and a truncated conical discharge hood 14 integrally connected to vortex chamber 12. Both of vortex chamber 12 and discharge hood 14 are tapered such that the widest end of vortex chamber 12 connects to the narrowest end of discharge hood 14. The narrowest end of discharge hood 14 is located at inner edge 24 and the widest end of discharge hood 14 is located at outer edge 26, wherein inner edge 24 and outer edge 26 define the outer limits of discharge hood 14. Discharge hood 14 of nozzle 10 is designed to further reduce the air pressure initially introduced into nozzle 10 and also to assist in determining the diameter of the combustion flame and spray pattern of the particles being combusted.

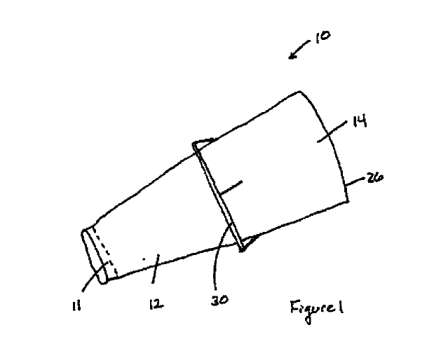

Nozzle 10 further comprises a plurality of blades 16 located on an interior side of vortex chamber 12. In an exemplary embodiment, blades 16 extend along all or a substantial portion of the length of the interior side of vortex chamber 12, wherein “substantial portion” comprises over about 80 percent of the length of the interior side of vortex chamber 12. In an exemplary embodiment, the terminal ends of the blades 16 are welded onto the interior side of vortex chamber 12. Each of blades 16 comprises a helical configuration so as to produce a centrifugal force inside nozzle 10 when in operation. As such, when in position, each of the blades overlaps and/or under laps at least one of the other blades. Although FIG. 1 depicts a plurality consisting of three blades, 2 or more blades may be used.

An optional feature of the nozzle of the present invention is the integration of a plurality of deflectors 18 onto an interior surface of discharge hood 14. When used, plurality of deflectors 18 assists in fine tuning the particle mixture and spray pattern of the particles emitted through nozzle 10. Each of deflectors 18 may vary in size and shape depending on the application and on the design of the combustion chamber.

Nevertheless, in an exemplary embodiment, each of deflectors 18 comprises a cavity 20 surrounded by a shell 22 attached to the interior surface of discharge hood 14. In an exemplary embodiment, each of shell 22 comprises a truncated conical configuration. Additionally, in an exemplary embodiment, shells 22 are welded onto discharge hood 14. Additionally, shells 22 taper such that the narrowest ends of shells 22 are directed towards, and preferably meet at, inner edge 24 of discharge hood 14, and the widest ends of shells 22 are directed towards, and preferably meet, at outer edge 26 of discharge hood 14. In an exemplary embodiment, each of shells 22 may be formed from about a 13 inch long and about a 2 inch wide solid stainless steel, or other corrosion resistant alloy, pipe 28. Pipe 28 may be bored through to form the desired truncated conical structure. Although six individual deflectors are depicted, it is contemplated that any number may be used to accomplish the purpose of directing the spray of particles out of the nozzle.

Nozzle 10 further comprises a mount 30 surrounding the outer periphery of nozzle 10. Mount 10 is preferably located at the point where vortex chamber 12 and discharge hood 14 meet. Mount 30 comprises a plurality of vias 32, wherein nails or screws may be inserted through vias 32 to further secure nozzle 10 onto a desired structure. Of course, fastening elements other than vias may be used to attach the nozzle to the desired structure so long as the structure to which the nozzle is mounted comprises complementary fastening elements.

Exemplary materials for forming the nozzle include stainless steel and other non-corrosive alloys, such as hastelloy®. The Example provided below describes exemplary measurements for forming the nozzle as described herein. However, it is noted that the size and taper of the nozzle may be varied based on the size of, for example, a combustion chamber, boiler, or furnace.

### EXAMPLE 1

### Dimensions of an Exemplary Nozzle

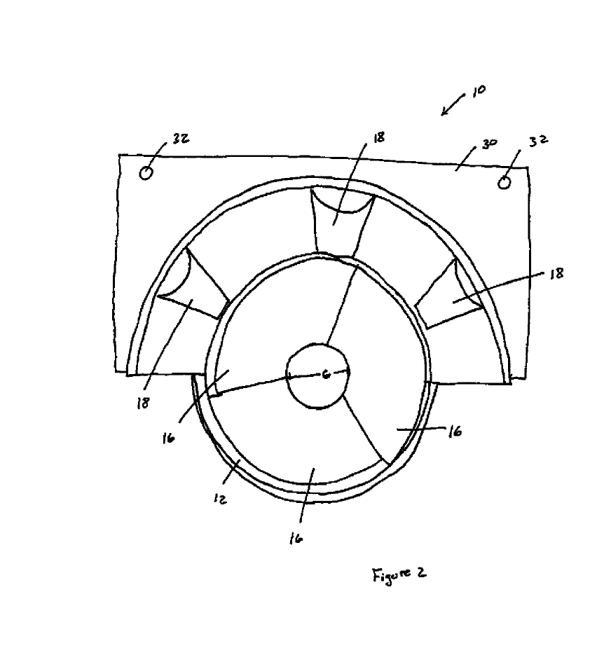

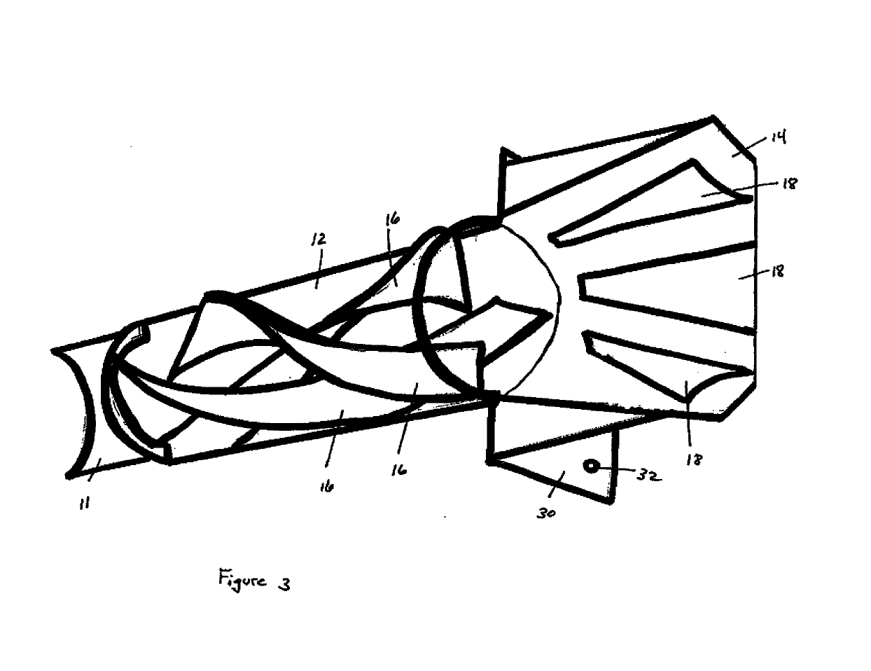

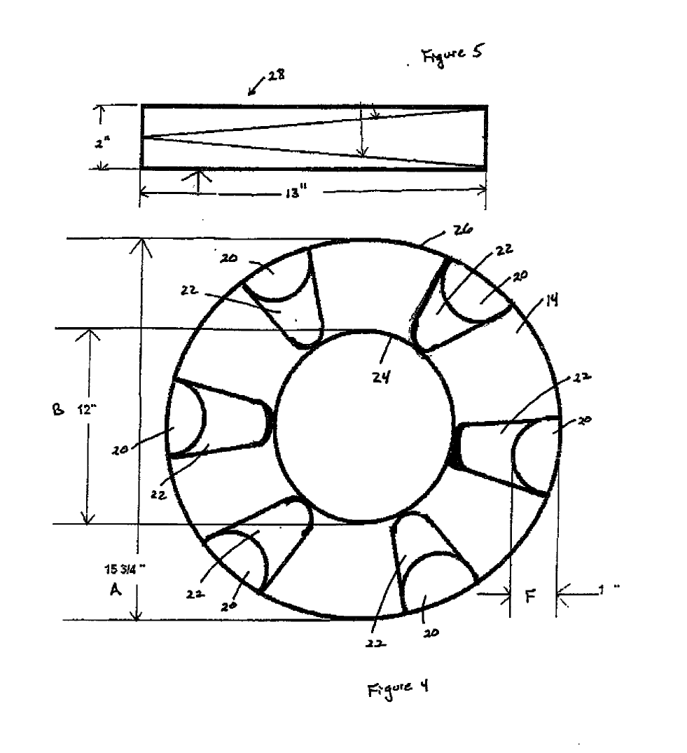

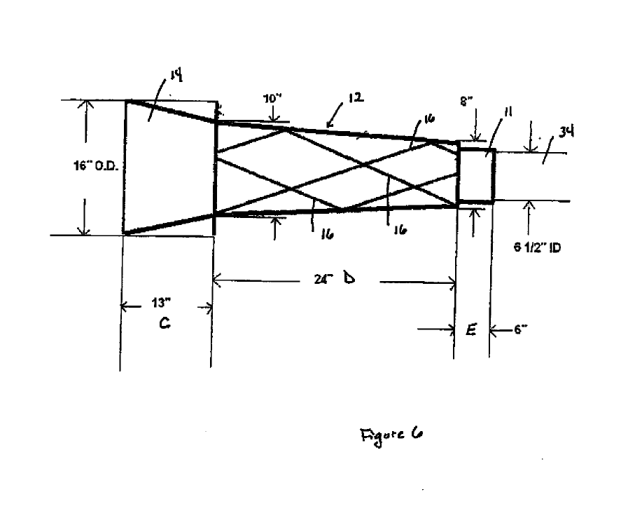

Referring to FIGS. 4 and 5, an exemplary nozzle was constructed having the following dimensions. Referring to FIG. 4, discharge hood 14 comprises an outer diameter A of 15.75 inches and an inner diameter B of 12 inches. Shell 22 comprises an opening having a maximum length F of 1 inch. Referring to FIG. 5, discharge hood 14 comprises a length C of 13 inches. Vortex chamber 12 comprises a length D of 24 inches. Receiver 11 comprises a length E of 6 inches and receives a supply pipe 34 having a 6.5 inch inner diameter. Referring to FIG. 2, plurality of blades 16 are arranged to create an inner diameter G of 3 inches.

An exemplary application of the nozzle described herein is in the transport of particles into a combustion chamber. In this application, it is envisioned that the particles enter the nozzle through the receiver under a pressure of about 1.3 pounds per square inch (“psi”). As the vortex chamber is tapered, the pressure at the widest end of the vortex chamber is less than that at the narrowest end. Accordingly, the velocity of the particles as they move through the length of the vortex chamber and into the discharge hood lessens. This is particularly important in the present application as it is desired to combust or to burn the particles as close as possible in the center of the combustion chamber. Where combustion occurs too close to the walls of the combustion chamber, a high amount of heat energy is more likely to contact the walls of the combustion chamber, thereby increasing the likelihood of damage to the walls. To accomplish burning towards the center of the combustion chamber, the velocity in which the particles are emitted from the nozzle into the combustion chamber is slowed. Such reduction in velocity is accomplished by reducing the amount of pressure within the vortex chamber, which, as previously stated, is accomplished by gradually increasing the internal diameter of the vortex chamber towards the discharge hood.

In this application, the particles may be blown into the vortex chamber by a pressurized flow of air. For example, the particles may be blown through a supply pipe, which is connected to the receiver. As the particles are blown through the vortex chamber and make contact with the plurality of blades, a centrifugal force is generated which assists in spreading the particles in the combustion chamber as desired.

The size and pitch of the plurality of blades inside the vortex chamber will vary based on the application. However, the construction and dimension is determined such that the particles emitted from the nozzle are sprayed in a desired pattern to create a desired flame size and length. The design and the arrangement of the plurality of blades preferably cause centrifugal motion to blow the heavier particles to the edges of the combustion chamber so that the particles have a longer burn time. Therefore, the plurality of blades is designed to create centrifugal force inside the nozzle. This process allows the fuel to exit the nozzle in such a manner so as to spread the particles in the combustion chamber as desired. The larger fuel particle sizes are ejected out of the nozzle at the outer perimeter of the nozzle which provides for the longest period of time for combustion available.

Furthermore, the mount may be secured to the outer side walls of the combustion chamber or boiler such that the outer edge 26 of discharge hood 14 jets into the combustion burner. In this application, it is preferred that fire brick insulation is used to buffer the nozzle and the combustion chamber.

The nozzle of the present invention is particularly useful when used in cooperation with a dedensification and delivery unit (“DDU”) as described in U.S. application Ser. No. 11/160,061, and which is incorporated herein in its entirety, and which is used to prepare and burn specification raw materials as a fuel source. In this embodiment, the nozzle of the present invention may replace or constitute the low volume blower hose which connects the refining area to the combustion chamber. In this manner, then, the nozzle of the present invention can convey a dedensified alternative fuel source to a combustion chamber in a controlled manner.

As required, detailed embodiments of the present invention have been disclosed herein. However, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure.

What is claimed is:

1. A nozzle comprising:
a truncated conical shaped vortex chamber integral with a truncated conical shaped discharge hood, wherein each of the vortex chamber and the discharge hood comprises an exterior side opposite to an interior side, and wherein each of the interior sides surround a cavity;
a plurality of helical shaped blades connected to the interior side of the vortex chamber and longitudinally extending through the cavity of the vortex chamber.

2. The nozzle of claim 1, wherein the vortex chamber comprises an end that tapers outwardly toward and connects to the discharge hood and an opposite end that tapers inwardly away from the nozzle, and the discharge hood comprises an end that tapers inwardly toward and connects to the vortex chamber and an opposite end that tapers outwardly away from the nozzle.

3. The nozzle of claim 2, further comprising a plurality of deflectors circumferentially disposed around the interior side of the discharge hood, wherein the deflectors are designed to regulate a flow pattern.

4. The nozzle of claim 3, wherein each of the deflectors forming the plurality of deflectors comprises a concave shaped shell defined by a top edge opposite to a bottom edge and by a first lateral edge opposite to a second lateral edge, wherein the shell widens from the top side to the bottom side, and wherein the first and second lateral edges are welded onto the interior side of the discharge hood such that a cavity is formed between the shell and the respective underlying interior side.

5. The nozzle of claim 2, further comprising a mount surrounding at least one of the exterior sides of the vortex chamber and the discharge hood, wherein the mount comprises one or more attachment elements for attaching the nozzle to a combustion chamber.

6. A nozzle for spraying particles into a combustion chamber, wherein the nozzle comprises:
a receiver for in-taking the particles;
a vortex chamber in communication with the receiver, wherein the vortex chamber is configured to reduce a level of pressure as the particles are transmitted from the receiver to the vortex chamber;
a plurality of blades disposed within an interior of the vortex chamber, wherein the blades are configured to disperse the particles into the combustion chamber in a desired spray pattern; and
a discharge hood in communication with the vortex chamber, wherein the discharge hood is configured to reduce a level of pressure as the particles are transmitted from the vortex chamber into the discharge hood.

7. The nozzle of claim 6, wherein each of the vortex chamber and the discharge hood comprises a truncated conical shape.

8. The nozzle of claim 7, wherein the vortex chamber comprises a first end that tapers outwardly toward and connects to the discharge hood and a second end opposite to the first end that tapers inwardly away towards and connects to the receiver, and the discharge hood comprises a first end that tapers inwardly toward and connects to the vortex chamber and a second end opposite to the first end that tapers outwardly away from the nozzle.

9. The nozzle of claim 7, further comprising a plurality of deflectors circumferentially disposed around an interior side of the discharge hood, wherein the deflectors are designed to further disperse the material into the combustion chamber in a desired spray pattern.

10. The nozzle of claim 9, wherein each of the deflectors forming the plurality extends from the first end to the second end of the discharge hood.

11. The nozzle of claim 6, wherein each of the plurality of blades comprises a helical configuration.

12. The nozzle of claim 11, wherein each of the plurality of blades extends along an entire length of the vortex chamber.

13. The nozzle of claim 6, further comprising a mount surrounding at least one of the vortex chamber and the discharge hood, wherein the mount comprises one or more attachment elements for securing the nozzle to the combustion chamber.

14. A method for spraying particles into a combustion chamber, wherein the method comprises:
connecting a supply pipe to a nozzle;
delivering particles and pressurized air through the supply pipe to the nozzle;
reducing the velocity of the particles as they move through the nozzle;
transmitting the particles from the nozzle to a combustion chamber; and
creating a centrifugal force as the particles move through the nozzle, thereby creating a particular spray pattern when the particles are transmitted from the nozzle to the combustion chamber;
wherein the nozzle comprises:
a receiver;
a truncated conical shaped vortex chamber having a cavity surrounded by an interior side;
a truncated conical shaped discharge hood having a cavity surrounded by an interior side; and
a plurality of helical shaped blades connected to the interior side of the vortex chamber and longitudinally extending through the cavity of the vortex chamber.

15. The method of claim 14, wherein the particles and pressurized air are delivered to the receiver.

16. The method of claim 15, wherein the velocity of the particles are reduced by arranging the vortex chamber in relation to the discharge hood such that the widest part of the vortex chamber is connected to the discharge hood, and such that the narrowest part of the discharge hood is connected to the vortex chamber.

17. The method of claim 16, wherein the centrifugal force is created by transmitting the particles and pressurized air past the plurality of helical shaped blades.

18. The method of claim 17, wherein the nozzle further comprises a plurality of deflectors circumferentially disposed around an interior side of the discharge hood, wherein each of the deflectors forming the plurality extends from the first end to the second end of the discharge hood, and wherein the centrifugal force is created by transmitting the particle and pressurized air past the plurality of deflectors.

19. The method of claim 18, wherein the nozzle further comprises a mount surrounding at least one of the vortex chamber and the discharge hood, wherein the mount comprises one or more attachment elements, and further wherein the combustion chamber comprises complementary attachment elements, and wherein the method further comprises mounting the nozzle directly onto the combustion chamber via the attachment elements and the complementary attachment elements.
